(19) United States
(12) Patent Application Publication
(10) Pub. No.: US 2003/0235334 A1
(43) Pub. Date: Dec. 25, 2003

(54) Method for recognizing image

(75) Inventor: Nobuyuki Okubo, Kahoku-gun (JP)

Correspondence Address: STAAS & HALSEY LLP, SUITE 700, 1201 NEW YORK AVENUE, N.W., WASHINGTON, DC, 20005, US

(73) Assignee: PFU Limited, Ishikawa (JP)

(21) Appl. No.: 10/462,796

(22) Filed: Jun. 17, 2003

(30) Foreign Application Priority Data
Jun. 19, 2002 (JP) 2002-177988

(51) Int. Cl. G06K 9/18; G06K 9/00

(52) U.S. Cl. 382/182; 382/164

(57) ABSTRACT

A method for recognizing an image is executed in an image recognition device to recognize the image of color image data. A separation unit executes separation processing to separate the color image data into a plurality of pieces of image data (image layers) for every color included in the color image data. A layout recognition unit and character recognition unit executes layout recognition processing and character recognition processing, respectively, on each of the plurality of pieces of image data.

### BACKGROUND OF THE INVENTION

1. Field of the Invention

This invention relates to a method for recognizing an image and, more particularly, to a method for recognizing an image by which layout of the image and characters of various colors may accurately be recognized from a color document having various colors.

2. Description of the Related Art

Image data of an image read out from a document by an image reading device such as a scanner device commonly undergoes character recognition processing (or OCR processing) for extraction of character data from the image. Conventionally, only a monochrome document such as a text document has been subjected to this character recognition processing, however, there are increasing cases recently that a document having therein color images (color document) such as brochures is also subjected to the character recognition processing in order to extract character data.

In the character recognition processing for such a color document, due to the conventional character recognition processing supporting only monochrome binary images, the color image is first binarized into the monochrome binary image through binarization processing by some method, and thereafter layout recognition processing and character recognition processing are executed onto the binary image to extract character data therefrom.

As described above, the conventional character recognition processing for color documents is executed on the binary image converted from the color image, and thus has the following disadvantages.

That is, despite the color document, color information therein is not utilized at all, which implies that there is no difference with a gray image nor meaning of being intended for color images.

Furthermore, although (a color of) characters differ from their background color in the color document, the colors of characters and background may occasionally be converted together to black (or white) as a result of the binarization processing. In this case, the characters disappear in the binary image, thus making them unrecognizable.

Moreover, as described above, the conversion of the colors of the characters and background into black (or white) resulted from the binarization processing does make layouts of the characters unrecognizable. The character recognition processing is normally executed after layouts (arrangements) of characters are recognized. Accordingly, failed layout recognition may not be succeeded by the character recognition processing.

### SUMMARY OF THE INVENTION

It is an object of the present invention to provide a method for recognizing an image by which the image of various colors may accurately be recognized from a color document having various colors.

The method for recognizing an image of the present invention is a method for recognizing an image in an image recognition device which recognizes images of color image data. The method comprises separation processing to separate the color image data into a plurality of pieces of image data for each of color determined to be the same color, and recognition processing on each of the plurality of pieces of image data.

According to the method for recognizing an image of the present invention, the recognition processing is executed on each of the plurality of pieces of image data obtained by separating the color image data for every color, without binarizing the color image. Therefore, color characteristics of the color document may be utilized, for example when the color document includes characters different for every color. Furthermore, in the color document in which the colors of characters and background are different, the conversion of them together into black (or white) and consequently caused disappearance of the characters (character information) may be prevented, and the layout recognition is prevented from being disabled and smoothly succeeded by the character recognition processing, then the character recognition may resultantly be performed. This allows accurate recognition and extraction of images of various colors from many existing color documents including various colors.

### BRIEF DESCRIPTION OF THE DRAWINGS

FIG. 1 is a diagram showing a constitution of an image recognition device.

FIGS. 2A and 2B are diagrams showing a configuration of the image recognition device.

FIG. 3 is an image recognition processing flow.

FIG. 4 is an image recognition processing flow.

FIGS. 5A and 5B are diagrams for illustrating the image recognition processing.

FIGS. 6A and 6B are diagrams for illustrating the image recognition processing.

FIGS. 7A and 7B are diagrams for illustrating the image recognition processing.

### DETAILED DESCRIPTION OF THE PREFERRED EMBODIMENTS

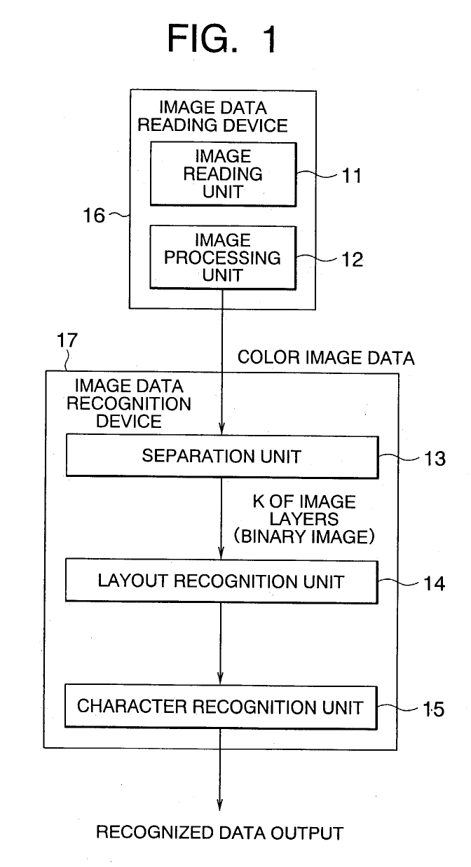

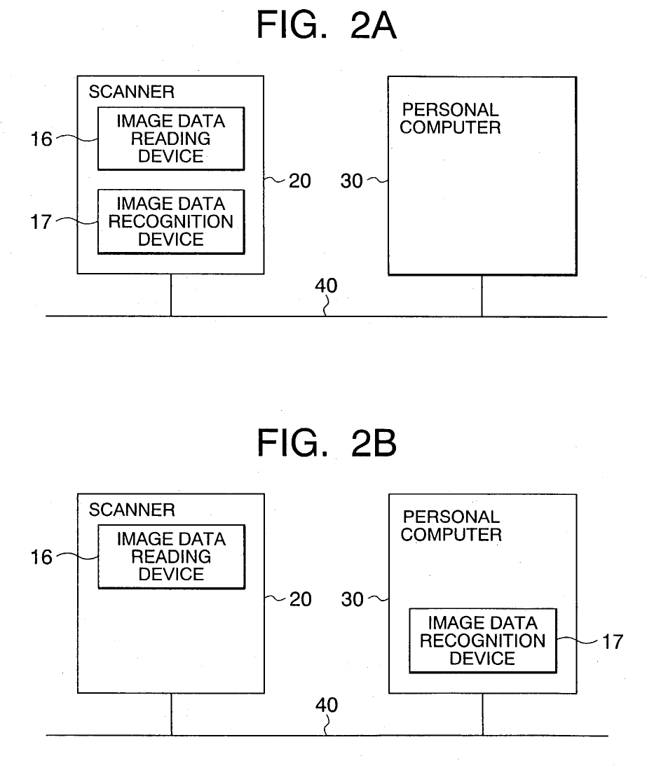

FIGS. 1 and 2 are diagrams showing a configuration of an image recognition device, and particularly, FIG. 1 shows a constitution of a method for recognizing an image according to the present invention, and FIG. 2 shows a constitution of the image recognition device such as a scanner device employing the method for recognizing an image of the present invention.

The image recognition device of the present invention comprises an image reading unit 11, an image processing unit 12, a separation unit 13, a layout recognition unit 14, and a character recognition unit 15. The image reading unit 11 and the image processing unit 12 constitute the image data reading device 16, and the separation unit 13, the layout recognition unit 14, and the character recognition unit 15 constitute the image data recognition device 17. In this embodiment, the image data reading device 16 and the image data recognition device 17 are provided to a scanner (scanner device) 20, as shown in FIG. 2A. The scanner 20 is connected to a personal computer 30 via a network such as a LAN (Local Area Network), or a well-known interface (hereinafter referred to as network) 40.

The image reading unit 11 comprises, for example, well-known CCDs (Charge Coupled Device) and the like, and it reads optically images (original images) from image surfaces of a double-sided document or a single-sided document which is automatically placed onto a read table, for example, by an automatic document sheet feeder, and then amplifies them, to thereby output read signals (analog signals) of respective colors of R (red), G (green), and B (blue) to the image processing unit 12. In this embodiment, the image reading unit 11 is set so as to read a color image from a document image in accordance with a read mode instruction inputted from an operational panel (not shown). The image reading unit 11 is capable of reading gray images and monochrome images in accordance with the inputted instruction.

The image processing unit 12 converts the read signals of each RGB color transmitted from the image reading unit 11 from analog (A) to digital (D), and generates total 24-bit (full) color image data where each color of RGB is represented by 8 bits. The image processing unit 12 transmits the color image data to (the separation unit 13 of) the image data recognition device 17 for the purpose of image recognition processing.

The image data recognition device 17 executes image recognition processing, that is, layout recognition processing and character recognition processing (OCR processing). In this embodiment, the image data recognition device 17 executes separation processing for separating the color image data into a plurality of single color image data prior to the image recognition processing. Therefore, the image recognition processing is performed to a plurality of single color image data separated in the separation processing.

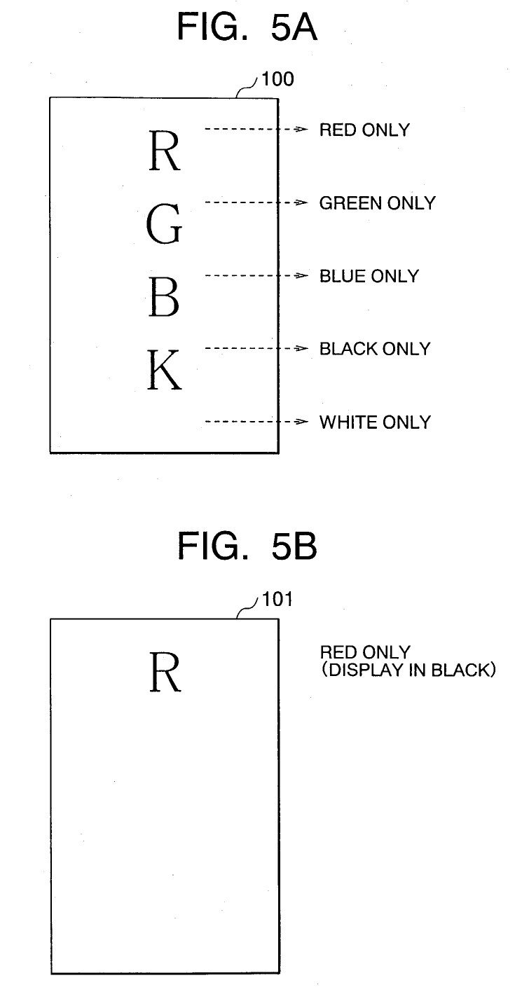

The separation unit 13 converts the color image data transmitted from the image processing unit 12 pixel-by-pixel into data for coordinates in an L*a*b* color space. Based on which the separation unit 13 determines a color of each pixel, the separation unit 13 forms a plurality of pieces of image data (hereinafter referred to as image layers) separated based on each color from the document image (original image), and determines the color numbers K included in the document. That is, image (data) of the full color document is separated into image (data) of each color (see FIG. 5 ff.). In this embodiment, image layers of each color after the separation are displayed (or outputted) not in relevant colors (the colors of the image layers) but in, for example, black color. It may alternatively be possible that image layers of each color are displayed (or outputted) in the relevant colors.

More specifically, the separation unit 13 determines a spacing (Euclidean distance) between coordinates of the color image data in the L*a*b* color space, and if the spacing is within a prescribed distance (threshold value) that is set in advance, it is determined to be the same color. This threshold value may be determined almost accurately and empirically, which means to allow the separation of colors so as to be consistent with human perception of color. The image of the color image data is thus separated into a plurality of images for every color existing in the image. The number of image layers K separated from the color image data is different depending on the color document, and is unclear before the separation but is usually made clear (determined) only after the separation. When the color numbers included in the color document is apparent or when colors used in lots of portions may be separated, it is alternatively possible to limit the colors to be separated, that is, the number of image layers. For example, by limiting the image layers so that the image layers of only red, green, blue, black, white, and the like are extracted, processing loads may advantageously be reduced.

Note here that the L*a*b* color space is a uniform color space on the basis of the XYZ color system, which was recommended by Commission Internationale De L'eclairage in 1976, and which provides coordinates agreed more with human perception of color than an RGB color space. In the separation unit 13, it is preferable to adopt the L*a*b* color space close to the human perception for the separation of image layers since it may reduce errors between the actual original image and the recognized image.

The separation unit 13 may alternatively form the image layers by using RGB data as it is of the color image data, or may alternatively form the image layers by using C (cyan), M (magenta), Y (yellow), and B (black) intended for print data.

Besides, the separation unit 13 binarizes the color image data to generate binary data (monochrome images) independently from the color image data, and transmits it to the layout recognition unit 14. In this embodiment, the separation unit 13 executes binarization processing on the color image data received from the image processing unit 12 for each of the previously determined K colors included in the document, to thereby obtain K sets of separate binary images that correspond to the color numbers (the number of image layers) included in the document. More specifically, as to one color, when a noticing pixel in the foregoing received color image data has the relevant color (the color of the image layer or the color of the piece of image data), the noticing pixel (first pixel in the image layer) is converted into “1” or “black”, and when the noticing pixel has a color other than the relevant color, the noticing pixel (second pixel in the image layer) is converted into “0” or “white”. The separation unit 13 repeats this processing for each of the K colors. When the relevant color (or the image layer) changes, the first and second pixels in image layer also change. As a result, K sets of binary images (K colors of image layers) may be obtained.

In this embodiment, the binarization processing is executed by projecting the color image data into the L*a*b* color space close to the human perception. This thus allows the separation of colors so as to almost accurately be consistent with human perception of colors. That is, images having colors other than the relevant color are all made “0” or white even when they are somewhat close to the relevant color, and images such as characters drawn in the relevant color are made “1” or black. For example, a red color and an orange color may accurately be separated. According to this processing, the image of the color image data may be separated into a plurality of images according to every color existing in the image.

The layout recognition unit 14 executes the layout recognition processing on (image data of) each image layer of every color, for example, through well-known histograming or labeling.

The character recognition unit 15 executes character recognition processing (OCR processing) on (image data of) each image layer of every color, for example, through well-known pattern matching or the like, to thereby output character information (data of recognized characters and positions thereof).

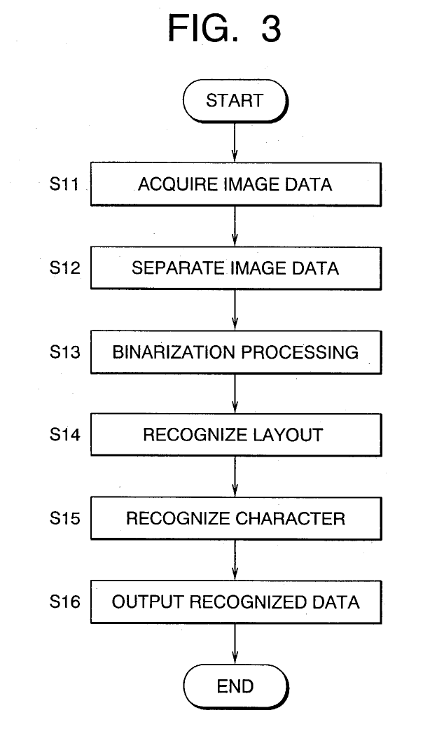

FIG. 3 is an image recognition processing flow and shows an image recognition processing for the color image data that is performed by the image recognition device of the present invention.

When the image reading unit 11 transmits the read signals of each RGB color which are read out from the original image of one page to the image processing unit 12, the image processing unit 12 performs A/D conversion of the read signals to generate the color image data, and transmits it to the separation unit 13. Thus, the separation unit 13 obtains the color image data (step S11).

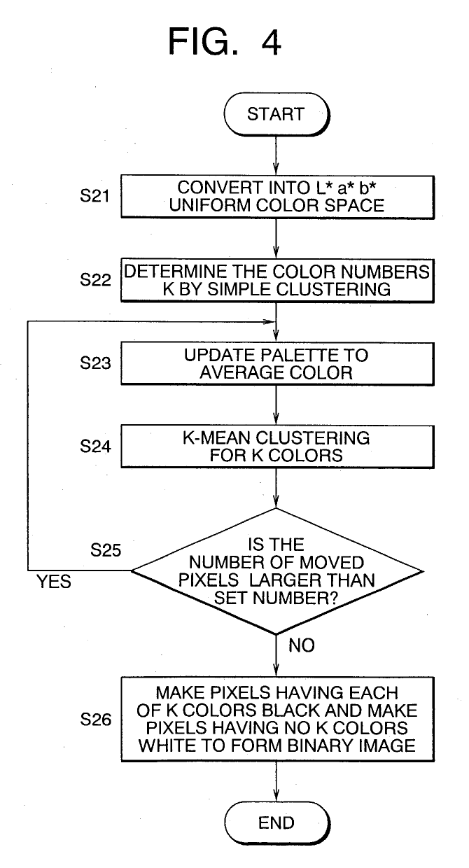

The separation unit 13 determines colors of the obtained color image data pixel-by-pixel and generates a plurality of image layers separated for every color included in the color document image (step S12). This will be described later with reference to FIG. 4. Next, the separation unit 13 executes the binarization processing in which a noticing pixel of the relevant color is converted to “1” and a noticing pixel of a color other than the relevant color is converted to “0”, onto the generated image layers of every color to thereby form binary images, and then transmits them to the layout recognition unit 14 (step 13). That is, the image layers of every color consisting of binary images are transmitted.

After this processing, the layout recognition unit 14 executes the well-known layout recognition processing respectively on the image layers of every color that consist of the binary images, and then transmits the image layers of every color that consist of the binary images to the character recognition unit 15 (step S14). For example, by means of histograming in which black pixels are collected in a main or sub scanning direction of the document, or labeling in which fragment images having continuous black pixels are extracted and added with labels, the layout recognition processing is executed for specifying areas where images are drawn.

Next, the character recognition unit 15 executes the well-known character recognition processing respectively on the image layers of every color that consist of the binary images on the basis of the result of the layout recognition processing (step S15), and then outputs the resultant images and character information (recognition data indicating images and characters, and positions thereof) (step S16). More specifically, the data of recognized images and characters are outputted to, for example, an external device or, alternatively, displayed on a screen or printed out.

FIG. 4 is an image recognition processing flow and shows the separation processing and binarization processing for the image layers that are executed by the separation unit 13 in steps S12 and S13 of FIG. 3.

When receiving the color image data, the separation unit 13 performs coordinate conversion for every pixel of the color image data from the RGB color space into the L*a*b* (uniform) color space (step S21). More specifically, the separation unit 13 converts 24-bit RGB data in each pixel (coordinates in RGB color space) into data for coordinates in the L*a*b* color space that are represented pixel-by-pixel, for example, by lightness L* (0 to 100 levels), hue a* (−127 to +127 levels), and saturation b* (−127 to +127 levels). Besides, the separation unit 13 simplifies pixel levels of the lightness L*, hue a*, and saturation b* to three levels of X1, X2, and X3, respectively, for example, X=10, X2=10, and X3=10. In this case, pixels are classified into 1000 patterns (clustering) by the following processing. This makes the processing simple rather than the clustering such pixels having the former levels.

On the basis of the result of this processing, the separation unit 13 executes the clustering on each pixel in the L*a*b* color space, and determines the color numbers K (=n, n is a natural number) in the color image data in accordance with the result of the clustering (step S22), the number which is used in K-mean clustering. More specifically, the separation unit 13 determines the Euclidean distance between respective pixels in the L*a*b* color space, and executes simple clustering on every pixel based on the determined distance in order to classify all pixels into any one of colors (clusters or palettes). Thus, the separation unit 13 separates the color image data into image layers for every color, that is, a plurality of pieces of image data. The color numbers K in the separated color image data is identical to the number of clusters and the number of image layers K.

At this time, the separation unit 13 executes the following processing specifically. The separation unit 13 prepares a palette for white color generally considered to be used in a great portion (average color: L=0, a*=0, b*=0) and a palette for black color (average color: L=100, a*=0, b*=0) as palettes used for classifying pixels in initial processing of step S22. Then, the separation unit 13 determines the Euclidean distance between the noticing pixel and (the color of) each palette existing at that time. When the Euclidean distance of the noticing pixel relative to the closest palette is within a preset color difference (distance) range, the noticing pixel is classified into the closest palette. To the contrary, the Euclidean distance of the noticing pixel relative to the closest palette is beyond the preset color difference range, a new palette for the noticing pixel color is formed and the noticing pixel is classified into such a new palette. The color of the new palette (average color) at this time is the same as the noticing pixel color. The separation unit 13 executes the above processing on every pixel to thereby classify all the pixels in the color image data into any one of color palettes (clusters). Consequently, the number of palettes corresponds to the color numbers K included in the color image data, and thus the color numbers for classifying the color image. data is determined as K colors.

When the determined color numbers K is large, a threshold value may alternatively be determined for the color numbers. More specifically, when the color numbers K is larger than the threshold value, palettes having a prescribed number or less of classified pixels may be integrated or eliminated in order to decrease the number of palettes, for example. Alternatively, only palettes having a prescribed number or more of classified pixels may remain for use. In this case, a palette whose Euclidean distance relative to the remaining palette is within a prescribed range may be integrated into the remaining palette, and a palette other than that may be eliminated.

In the initial processing of step S22, it is also alternatively possible to prepare all palettes for (image layers of) colors to be generated, and to ignore (eliminate) pixels that cannot be classified into any prepared palette or classify them into a white palette without generating new palettes. In this case, it is desirable to set the foregoing range slightly wide. The prepared palettes are preferably, for example, read, green, blue, black, and white, which are three primary colors, black as a usual color of characters, and white as a background color of the document.

Next, the separation unit 13 updates the average color of each of K sets of palettes according to pixels composing each palette at that time (step S23). More specifically, the separation unit 13 makes the colors of pixels classified at that point into the palette uniform, to thereby determine a color (average color) indicative of characteristics of the palette (or, a central point in the L*a*b* color space). An average value is calculated by determining an average of L, a*, and b* values in each pixel.

Next, the separation unit 13 executes the well-known K-mean clustering on K colors (K sets) of palettes (step S24). More specifically, the separation unit 13 determines the Euclidean distance of noticing pixel relative to each of the average colors (the values updated in step S23) of K sets of palettes, and classifies again the noticing pixel into the closest palette. Accordingly, there exist two cases that the noticing pixel is classified into the (former) palette to which it originally belongs in step S22, and that it is classified (hereinafter referred to as moved) into another palette other than the above palette. The separation unit 13 executes the above processing on every pixel to thereby classify again all the pixels in the color image data into K sets of palettes.

The separation unit 13 determines the number of pixels that are moved into different palettes, and examines whether the number of such moved pixels is larger than a prescribed value or not (steps S25). When the number of the pixels is larger than the prescribed value, the separation unit 13 repeats the processing from step S23 through step S25 due to unstable clustering (non-convergence). The separation unit 13 thus makes the number of the moved pixels converge below the prescribed value.

The number of such moved pixels is below the prescribed value, which means stable clustering (convergence), therefore the separation unit 13 executes the binarization processing for the color image data using K sets of palettes to form each color of (K sets of) binary images, or image layers (step S26). More specifically, in the color image data, the separation unit 13 converts pixels classified into a certain palette to black or “1”, and converts pixels of colors other than the relevant color to white or “0”, to thereby form the binary image for the palette or color. That is, the separation unit 13 obtains (one) image layer for the relevant color. The separation unit 13 repeats this processing on K sets of palettes and obtains (K sets of) image layers for K colors. Therefore, each of the image layers is the binary image in which pixels having the relevant color are drawn in black.

For example, it is assumed that, in a color document 100 shown in FIG. 5A, a letter R is printed in red, a letter G in green, a letter B in blue, and a letter K in black, on a white ground color (background color).

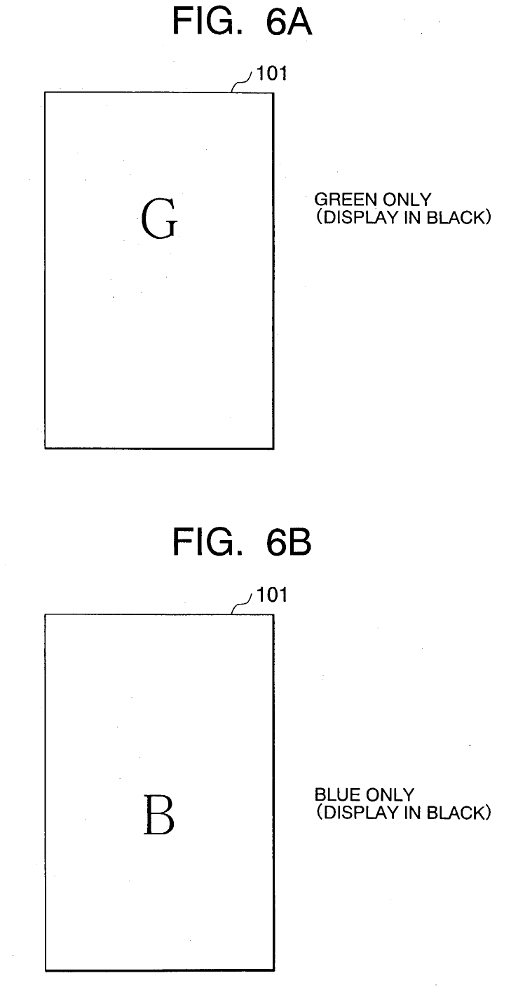

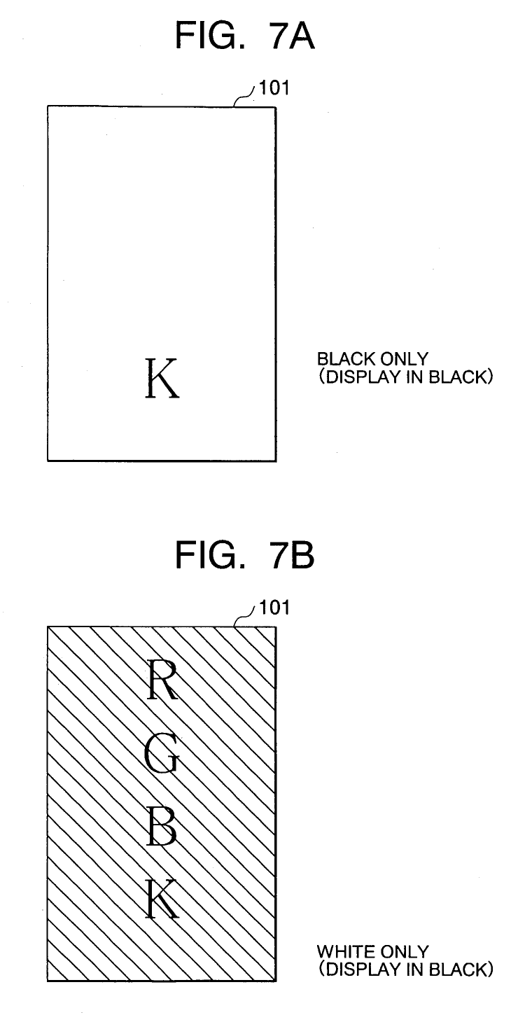

In this case, in addition to while and black palettes prepared in initial setting, red, green, and blue palettes are generated, and K is determined to be 5 (step S22). Therefore, when K-mean clustering converges (step S25), five palettes of white, black, red, green, and blue are used to form such five colors of image layers (step S26). That is, in a red image layer 101, the letter R printed in red is displayed (in black) as shown in FIG. 5B. Likewise, in green, blue, and black image layers 101, the letters G, B, and K printed in green, blue, and black, respectively, are displayed (in black) as shown in FIGS. 6A, 6B, and 7A, respectively. In a white image layer 101, a portion of the ground color (shown by half-tone dot meshing) in the document 100 is displayed (in black) as shown in FIG. 7B, and the letters R, G, B, and K are displayed as void characters (shown in black in the drawing).

Thus, the color image data in FIG. 5A are separated into image layers having image data of each color in FIGS. 5B to 7B, whereupon the layout recognition processing and character recognition processing are executed on every image layer. Therefore, the letter R is extracted by the character recognition from the image layer in FIG. 5B. Similarly, the letters G, B, and K are extracted by the character recognition from the image layers in FIGS. 6A, 6B, and 7A, respectively. From the image layer in FIG. 7B, the void characters R, G, B, and K are extracted by the character recognition. Therefore, even when void characters or red color characters are drawn on a black ground or when various colors of characters are drawn on a ground of various colors, for example, color brochures, characters of the relevant color may accurately be extracted as long as the colors are different. In addition, even when various patterns of various colors are drawn, such as color posters, they may be extracted by the layout recognition. Thus, a situation such that characters in FIG. 5B and characters in FIG. 6A, for example, are confusedly converted into black or white resulting in failure of the character recognition is avoided, and the color document 100 may accurately be processed in the layout recognition and character recognition.

Note here that, according to the conventional character recognition processing, only a letter K printed in one color, e.g., black color, is extracted as a target of the character recognition processing and is then outputted, while letters R G, and B of other colors are not extracted nor recognized.

Although the present invention has been described in terms of its preferred embodiments, it is believed obvious that modifications and variations may be made in the present invention according to the purpose thereof.

For example, in the forgoing description, it is described a case that the image processing device of the present invention is provided in the scanner device 20 as shown in FIG. 2A, however, the constitution of the image processing device of the present invention is not limited to this case. It may alternatively be possible, as shown in FIG. 2B, to provide only the image data reading device 16 in the scanner device 20 and to provide the image data recognition device 17 in the personal computer 30 (or, printer device, facsimile device, or the like). In this case, the color image data transmitted from the image data reading device 16 is received via the network 40 by the image data recognition device 17 in the personal computer 30.

As described above, in the method for recognizing an image according to the present invention, the recognition processing is executed on each of a plurality of pieces of image data obtained by separating the color image data for every color, without binarizing the color image. Therefore, color characteristics of the color document may be utilized, for example when the color document includes characters different for every color. Furthermore, in the color document in which the colors of characters and background are different, the conversion of them together into black and consequently caused disappearance of the characters may be prevented, and the layout recognition is prevented from being disabled and smoothly succeeded by the character recognition processing, then the character recognition may resultantly be performed. This allows accurate recognition of images of various colors from the color document including various colors.

What is claimed is:

1. A method for recognizing an image in an image recognition device to recognize color image data, the method comprising:
separation processing to separate color image data into a plurality of pieces of image data for each of color determined to be the same color; and
recognition processing on each of the plurality of pieces of image data.

2. The method for recognizing an image according to claim 1, wherein, in the separation processing, the color image data is converted pixel-by-pixel into data for coordinates in an L*a*b* color space, and a color of each pixel is determined based on the coordinates, to thereby separate the color image data into the plurality of pieces of image data.

3. The method for recognizing an image according to claim 2, wherein the color numbers K is determined by simple clustering performed on each of the pixels of the color image data, and each of the pixels is classified into any one of the colors by K-mean clustering for the color numbers K.

4. The method for recognizing an image according to claim 1, wherein, in the separation processing, each of the separated plurality of pieces of image data is configured as a binary image by converting first pixels to “black” and second pixels other than the first pixels to “white”, the first pixels in a piece of image data having a color of the piece of image data and the second pixels in the piece of image data not having the color of the piece of image data.

5. The method for recognizing an image according to claim 1, wherein, in the recognition processing, layout recognition and subsequent character recognition are executed on each of the plurality of pieces of image data.
